(19) United States
(12) Patent Application Publication
(10) Pub. No.: US 2025/0317646 A1
(43) Pub. Date: Oct. 9, 2025

(54) Learned Dynamic Camera System Control for Human-Pose Estimation

(71) Applicant: Ultraleap Limited, Bristol (GB)

(72) Inventors: Juno Wilkinson, Bristol (GB); Shlok Mohta, Bristol (GB); Iain Wallace, Bristol (GB)

(21) Appl. No.: 19/098,958

(22) Filed: Apr. 2, 2025

Related U.S. Application Data
(60) Provisional application No. 63/574,096, filed on Apr. 3, 2024.

(51) Int. Cl. H04N 23/60; H04N 23/611

(52) U.S. Cl. CPC H04N 23/64; H04N 23/611

(57) ABSTRACT

To get optimal camera images for human pose estimation, including, specifically, hand tracking, a network is trained to simultaneously do hand pose estimation and camera control. By combining these tasks into a single network, the accuracy of the hand tracking during training is used as feedback to guide how the network controls the camera parameters. This approach is enhanced by independently controlling the exposure parameters of each participating camera or sensor. This expands the dynamic range beyond what is possible with a single camera, enabling improved functionality across a broader range of environments or with lower bit depths and reduced system power. This method is applicable to systems with any number of tracking sensors, as it involves capturing multi-exposure images of the scene volume both temporally and spatially.

### PRIOR APPLICATIONS

This application claims the benefit of the following application, which is incorporated by references in its entirety:
U.S. Provisional Patent Application No. 63/574,096, filed on Apr. 3, 2024.

### FIELD OF THE DISCLOSURE

The present disclosure relates generally to improved techniques in human pose estimations in various lighting conditions.

### BACKGROUND

Human pose estimation, such as optical hand tracking needs to work in a variety of lighting conditions. As such, systems of camera control such as illumination and auto-exposure are required in order to avoid clipping and maximizing image information that is relevant to hand pose estimation. Most auto-exposure systems are designed to acquire camera images that look good to humans and are based on heuristics that do not necessarily align with requirements for hand tracking. It is also hard to specify the requirements exactly as hand tracking is a complex problem often solved with machine learnt solutions. Thus, the qualities of the image the networks depend on are not well-specified. Image quality and tracking performance are not the only properties that must be optimized in such a system. Power consumption is also at issue, so there is a need to optimize illumination and camera control for jointly tracking performance and power. Furthermore, hand tracking might not be the only use of the images. In some systems this could be extended to joint hand tracking and egomotion (either shared cameras feeding two systems or a joint system as joint estimation of hands and egomotion).

In a tracking system, the tracking quality may be affected by the system's limited capability to accurately capture the environment's dynamic range in real time. Digital camera systems store images in “bits,” and a lower bit representation of a high dynamic range scene can restrict tracking quality. This issue may worsen in systems that use sensors with low bit depth or operate at a lower bit depth to save power or to achieve faster readout speeds for more efficient real-time tracking. This is particularly a problem for human-worn portable devices such as XR headsets.

Deep learning approaches to auto-exposure (AE) are in the prior art. See:
1. Onzon et al., Neural Auto-Exposure for High-Dynamic Range Object Detection (2021 IEEE/CVF Conference on Computer Vision and Pattern Recognition (CVPR) DOI: 10.1109/CVPR46437.2021.00762).
2. Yang et al., Personalized Exposure Control Using Adaptive

Metering and Reinforcement Learning (JOURNAL OF LATEX CLASS FILES, VOL. 14, NO. 8, August 2015 arXiv: 1803.02269v3)

There also exist classical vision approaches to task specific AE:
Zhang et al., Visual Odometry: Active exposure control for robust visual odometry in HDR environments (2017 IEEE International Conference on Robotics and Automation (ICRA) DOI: 10.1109/ICRA.2017.7989449).

Headsets that have hand tracking (Quest, Pico, Vision Pro) have auto exposure on their tracking cameras, but the implementation details are not publicly available. As such there is no known attempt to develop an auto exposure explicitly for hand tracking. By producing cameras and illumination systems (as well as implementing systems on other cameras), it is possible to increase performance further by jointly optimizing control of the camera, illumination and the machine learnt hand tracking.

The solution is to go beyond just an AE algorithm and have the hand tracking model itself predict camera system parameters (optionally including illumination).

In digital camera systems, it is common to use images captured at various exposures to create a high dynamic range representation of a scene. These techniques typically aim to produce High Dynamic Range (HDR) images that enhance performance in specific tasks or improve visual quality for human observation. But there is no known instance where images captured at different exposures have been applied to human pose tracking system.

This approach leverages the enhanced dynamic range offered by images taken at varying exposures. In this system, the exposure settings for each camera are collectively learned as part of the training and managed by the hand tracking model: this joint optimization of the problems to expand the dynamic range and/or improve exposure for human pose estimation is novel. It is also believed it is novel to consider an optimization approach that can be applied across different sensor types (e.g. event cameras, lidar, etc.).

### SUMMARY

To get optimal camera images for human pose estimation, e.g. specifically hand tracking, a network is trained to simultaneously do hand pose estimation and camera control. By combining these tasks into a single network, the accuracy of the hand tracking during training is used as feedback to guide how the network controls the camera parameters.

The approach is enhanced by independently controlling the exposure parameters of each participating camera or sensor. This expands the dynamic range beyond what is possible with a single camera, enabling improved functionality across a broader range of environments or with lower bit depths and reduced system power. This method is applicable to systems with any number of tracking sensors, as it involves capturing multi-exposure images of the scene volume both temporally and spatially.

### BRIEF DESCRIPTION OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIG. 1 shows a schematic of recurrent training with augmentation in the loop.

FIG. 2 shows a schematic of bracketed training with augmentation in the loop.

FIG. 3 shows a schematic of inference time.

FIG. 4 shows a diagram of spatial multi-exposures.

FIG. 5 shows a diagram of temporally multi-exposures.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

There are multiple ways of achieving the end result of a system that is capable of jointly achieving hand tracking and camera parameter control.

1. Recurrent Training with Augmentation in the Loop

The first approach is to train it recurrently while augmenting the input images in the training loop in order to simulate the changing camera parameters as instructed by a camera control network. It is similar to a reinforcement learning approach where a camera control network (CCN) is the agent, and the reward is determined by the hand tracking loss function.

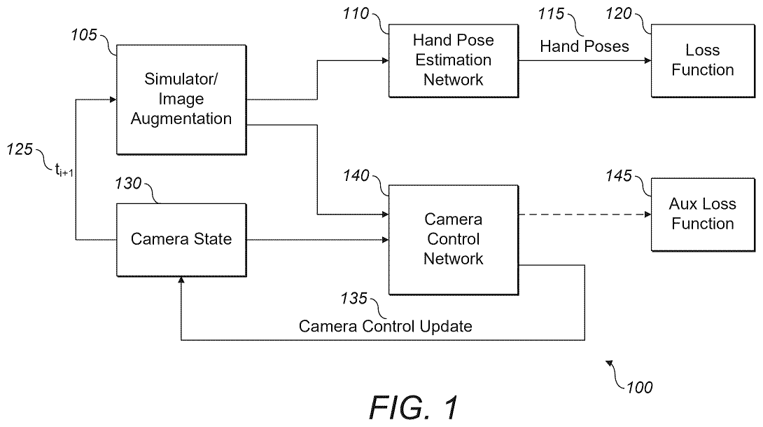

Turning to FIG. 1, shown is a network layout 100 at training time. The network has two main sub-networks, one for camera control and one for hand pose estimation. At the input to the model at training time t₁₊₁ 125, there is a simulator/image augmentation module 105 that simulates changes to camera parameters in the training loop. If training with synthetic data, this could also be a simulator in the training loop. During training time, there is a set of variables that represent a virtual camera state that serves as input to this module. Specifically, the simulator/image augmentation module 105 outputs to a hand pose estimation network module 110, which outputs hand poses 115 to the loss function module 120.

Further, at the input to the model 125 at training time t₁₊₁, there is camera state module 130 outputs to a camera control network module 140. The simulator/image augmentation module 105 also outputs to the camera control network module 140. The camera control network module 140 outputs to an optional auxiliary loss function module 145 and also sends a camera control update 135 back to the camera state module 130

In the forward pass, the simulator/image augmentation module 105 outputs images based on the current camera state that simulate the output of a real camera with that current state. The camera state is comprised of values such as Exposure Value (EV), gain, illumination LED pulse width, and other control parameters with the need to learn to control. At the beginning of each sequence, this camera state is randomized in order to force the network to learn to adjust the camera parameters from towards ones more optimal for hand tracking. The output images are fed to the CCN and the hand pose estimation network. The hand pose estimation network then uses these images to estimate hand poses. The CCN also takes as input the current state and with the augmented images, produces an output that updates the camera state for the next time step.

When it comes to the backward pass, the key detail is that the camera control network does not need its own loss function and instead is updated from gradients that come from the loss function of the hand pose estimation network. The network is recurrent, and gradients pass back through the hand pose estimation network module 110 to the previous time step of the camera control network. To illustrate the flow of gradients, in FIG. 1, follow the arrows backwards from loss function. Gradients from the hand pose loss function 120 pass back through hand pose estimation network module 110, back through the simulator/image augmentation module 105 and back to the previous time step of the input to the model 125.

Certain camera parameters such as LED illuminance have a cost in terms of power consumption on deployed devices like headsets where battery life is a premium. It's possible to apply a loss term on the camera control output that seeks to minimize such parameters in order to tune the system to better fit the requirements of the deployed system, as indicated in FIG. 1 by the optional “optional auxiliary loss function module 145.

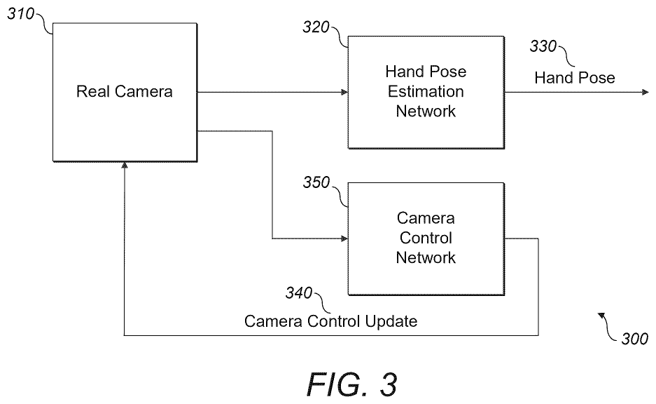

At inference time (FIG. 3, described below) there is no augmentation, or virtual camera state. The output of the camera control network is passed to a real camera to control its parameters.

2. “Bracketed” Training with Augmentation in the Loop

The second approach removes the need for training recurrently and passing gradients back through time steps, by instead having multiple parallel forward passes.

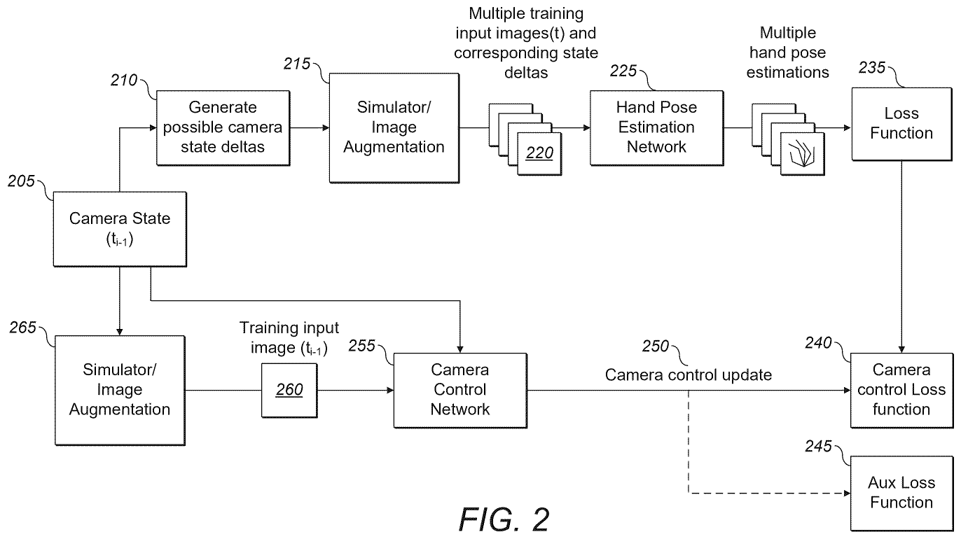

This approach is illustrated in FIG. 2. FIG. 2 shows a network layout 200 with a camera state module 205 at time tᵢ₋₁. This outputs to generate possible camera state details module 210, which outputs to a simulator/image augmentation module 215, which outputs to multiple training input images (t) and corresponding state deltas 220, which outputs to a hand pose estimation network module 225, which outputs to multiple hand pose estimations 230, which outputs to a loss function module 235, which outputs to a camera control loss function module 240. The camera state module 205 also outputs to a second simulator/image augmentation module 265, which outputs to a tracking input image 260 at time tᵢ₋₁, which outputs to a camera control network module 255. The camera state module 205 also outputs directly to the camera control network module 255. The camera control network module 255 outputs a camera control update 250 that outputs to the camera control loss function module 240 and optionally to an auxiliary loss function module 245.

In the forward pass at the beginning, there is an initial camera state much like approach 1, that is representative of a previous time step. Note that this doesn't need to be a true previous time step in a recurrent network sense, this state can effectively be randomized on any forward pass. The state is passed to the simulator/image augmentation module 215 to generate an image based on this camera state which is then passed on to the camera control network update 255 to generate a camera control update 250.

From the same camera state, a series of possible camera state deltas are generated and for each of these, a bracketed set of images are generated using the same simulator/image augmentation module 215. Each of these is given a forward pass through the network. The gradients from each of these can be used to update the network, however the loss of each image is ranked and used to determine what the best camera delta state was. This is then used in the loss function for the camera control network module 255. The difference between the predicted camera control update and the state delta that produced the image with the lowest hand pose loss is used to calculate the loss for the camera control net.

Much like approach 1, an auxiliary loss function module 245 can be provided to balance tracking performance against other hardware-based considerations. At inference time, like approach 1, there is no augmentation or virtual camera state, and the system reflects FIG. 3.

Turning to FIG. 3, shown is a network diagram 300 of the special case of FIG. 1 or 2 at inference time where there is no augmentation or virtual camera state. Shown is a real camera module 310, which outputs to a hand pose estimation network module 320, which outputs hand poses 330. The real camera module 310 also outputs to the camera control network module 350, which outputs camera control updates 340 back to the real camera module 310.

3. Training with Augmentation or Simulation Outside of the Loop

Given the engineering difficulty of placing a simulator in the training loop, the approaches described above can also be trained on simulator or augmented data where all the augmentation is done beforehand. As such, the system starts by creating multiple versions of the same dataset where the same view is reproduced for all variations of the camera parameters. In this approach, the simulator/augmentation modules in FIGS. 1 and 2. are replaced with a selection module that will select the relevant camera image from the video streams based on the input camera state.

This, however, does result in a dataset that grows in a polynomial manner for each additional camera parameter that there is a need to learn to control. This may prove unwieldy for certain situations.

4. Training with a Frozen Pre-Trained Network

Both approaches discussed above have presumed training the hand tracking network and camera control sub-network at the same time. This has the advantage in that there is no need to make as many assumptions on what sort of camera state is optimal for hand tracking.

However, it is possible as well to pre-train a hand tracking network without a CCN. The weights from this network can then be transferred to a network with a CCN and frozen and the CCN is trained independently. This approach can be taken for any of the approaches described above and will result in likely greater training stability at the cost of potentially suboptimal camera parameter control. This is because the CCN will learn to control camera parameters such that it matches what the hand tracking network saw at training time.

For the purpose of providing a real-time higher dynamic range input to the hand pose tracking system, all the training methodologies described above are equally applicable for the individual control of the camera exposure parameters.

Some key additions to the training methodologies described above are outlined as follows:

### A). Spatial Multi-Exposure Training:

In the training loop the CCN is responsible for predicting the exposure control parameters of the physical cameras in the tracking system given a set of input as defined in the methodologies above. At any given time “t”, these cameras look at same scene volume, taking multi-exposure images of the scene volume.

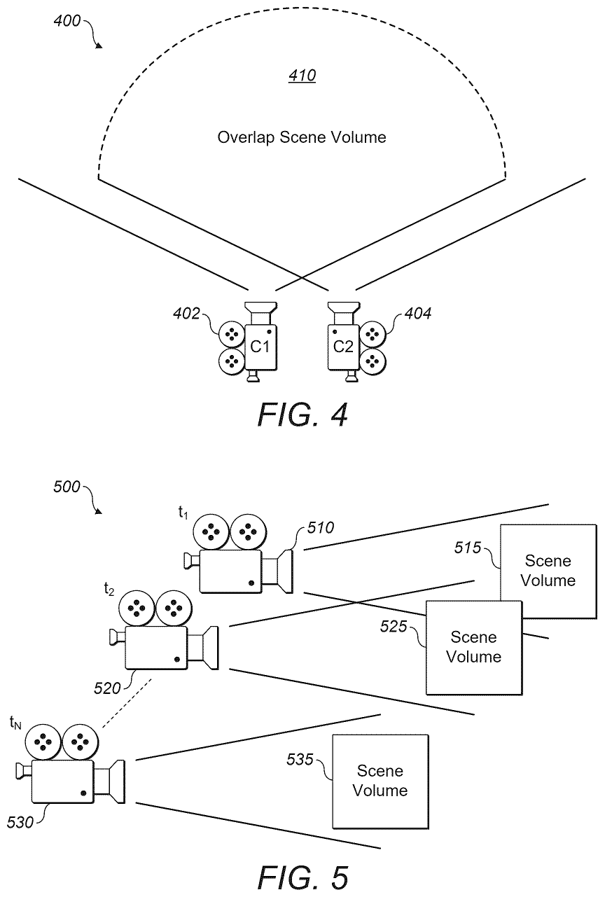

Turning to FIG. 4, shown is a diagram 400 of spatial multi-exposures where C1 402 and C2 404 are the different cameras taking image capture of the scene volume at different exposures. Also shown is the overlap scene volume 410.

For individual control of camera parameters for an arbitrary “N” (>1) participating cameras, there are few key considerations to be taken into account:

I. Have a singular CNN which outputs a set of “N” camera control parameters corresponding to each of the “N” participating cameras. Such a CNN would receive the current state and corresponding camera image of all the participating cameras and process them all together.

II. Have “N” individual CNN, corresponding to participating cameras, which outputs the corresponding camera control state. However, for these “N” individual CNN there are some additional points of consideration:

A. They all share the same model architecture and weights. This essentially means that all the “N” individual CNN are the same but takes input of current state and image from only an individual camera and outputs the camera control parameters of that particular individual camera in the list of all the “N” participating camera.

B. They all have different weights and may or may not share the same model architecture. In such a case, the input to the model may be the current state camera parameters and image from the camera in consideration or from all the cameras in the list of “N” camera, with the model output being the camera control parameters for the camera in consideration.

### B). Temporal Multi-Exposure Training:

In a hand pose tracking system that utilizes a mono-camera, it is possible to capture multiple images of the scene volume in quick succession, each at different exposures. This involves capturing scenes from time t₁ to t_{N}, where “N” represents a number greater than one. This multi-exposure capture of the scene is similar to how an HDR image is formed, however, instead of creating a singular HDR image, it feeds these multi-exposure captures to the system's learning component for joint optimization. The quantity of scene captures is limited by the real-time requirements of the tracking system. This limitation includes taking the “N” images at varied exposures and subsequently processing these images to determine the hand pose.

Turning to FIG. 5, shown is a diagram 500 where t₁ to t_{N} 510, 520, 530 are exposures taken at different times of the same scene volume 515, 525, 535 and provided to the tracking system.

The training of the tracking system with these “N” captures follows the same methodology outlined in Section I of the “Spatial Multi-Exposure Training.” Nevertheless, it is crucial to consider certain key aspects due to the real-time nature of the tracking system. These considerations include:
i. For time restricted tracking system, the CCN can be designed to output the number of successive captures “N” (>1) to be taken of the scene.
ii. Learning around any motion artifacts of the object, hands, due to spaced temporal exposures.

A key advantage of the ability to control camera parameters spatially and temporally in a hand pose tracking system is that it enables the system to receive inputs with a higher dynamic range, which is unachievable with cameras operating under fixed exposure settings. This approach addresses the limitation of existing systems in capturing the dynamic range of environments in real-time. For systems with power constraints, this technique offers a balance between power consumption and scene capture quality. Specifically, in power-limited systems, it permits the use of digital cameras at a lower bit depth, or cameras with inherently lower bit depths, while still capturing a broader environmental dynamic range by operating the cameras at varying exposures.

Taking the above into consideration, control over the CCN output related to camera parameters may be enhanced by limiting the model's output to a specific, fixed range for each camera. This approach ensures that all cameras operate within entirely distinct or only partially overlapping exposure domains. “Exposure” in this context includes camera states like EV and gain, or parameters controlling temporal sampling in an event camera. Implementing this enforced exposure range control on the cameras would enable the tracking system to receive image inputs with a higher dynamic range. This enhancement is in turn governed by the feedback received from the tracking quality during the training phase. It is important to note that this exposure range control applies to all the training methodologies previously mentioned, in addition to the CCN enhancements for spatial and temporal camera control.
So far as is known, this describes a system designed explicitly to work with hand tracking.
The network uses the main output task loss to train both parts of the network, meaning the network will simultaneously converge on good hand pose estimation as well as images that will support good hand pose estimation.
The camera control can also be jointly optimized to fit requirements of an edge device.
It can optimize for camera system properties alongside hand tracking (i.e., power consumption/illumination vs hand distance).
The tracking system's ability to process a higher dynamic range is improved by independently controlling the camera's exposure parameters, both spatially and temporally. This approach yields a more effective input than a higher bit camera alone or two lower bit cameras combined.
A High Dynamic Range (HDR) image is created by using images obtained at different exposure levels. Instead, the training model's internal state representation is enhanced by providing an input with an effectively higher dynamic range. This input is jointly optimized to meet the specific requirements of hand tracking.
The tracking system can be adjusted to balance power consumption and scene capture quality. This is achieved by either operating cameras at a lower bit depth or using lower bit cameras at an effectively higher bit rate. Such task dependent learned exposure adjustments enable the production of scene captures that would otherwise be impossible.
This technique could e.g. enable two cheaper less capable sensors to outperform a single more expensive more capable sensor.

### CONCLUSION

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A network trained to simultaneously do hand pose estimation and camera control, comprising:
hand pose estimation and camera control combined into a single network;
wherein accuracy of the hand pose estimation during training is used as feedback to guide how the network controls the camera parameters.
